(19) United States
(12) Patent Application Publication
(10) Pub. No.: US 2004/0267678 A1
(43) Pub. Date: Dec. 30, 2004

(54) Fuzzy logic impedance mismatch network for DSL qualification

(76) Inventors: Xiao M. Gao, Raleigh, NC (US); Wesley H. Smith, Raleigh, NC (US); Veda Krishnan, Raleigh, NC (US); Kanna Krishnan, Raleigh, NC (US)

Correspondence Address: Timothy N. Trop, TROP, PRUNER & HU, P.C., STE 100, 8554 KATY FWY, HOUSTON, TX, 77024-1841, US

(21) Appl. No.: 10/609,989

(22) Filed: Jun. 30, 2003

(51) Int. Cl. G06F 15/18

(52) U.S. Cl. 706/2

(57) ABSTRACT

An apparatus and technique for Digital Subscriber Line (DSL) telephone loop qualification that includes a fuzzy logic impedance mismatch network. The impedance mismatch network is used to increase the received echo of a transmit pulse signal to determine the telephone loop characteristics.

### CROSS-REFERENCE TO RELATED APPLICATIONS

This application relates to the following commonly assigned co-pending applications entitled:

“Estimation Of DSL Telephone Loop Capability Using CAZAC Sequence,” Ser. No. ______, filed Jun. 30, 2003, “Time Domain Reflected Signal Measurement Using Statistical Signal Processing,” Ser. No. ______, filed Jun. 30, 2003, all of which are incorporated by reference herein.

### BACKGROUND

This disclosure relates generally to Digital Subscriber Line (DSL) telephone loop qualification, and more particularly to use of fuzzy logic for determining if the telephone loop is qualified to carry a DSL signal.

Deployment of broadband services on a telephone loop is severely limited by the inherent properties of the copper cable and, in part, because initial deployment of the copper cable was aimed primarily at providing voice services to subscribers. Until the telephone loop electronics and plant are upgraded or replaced, as by installation of optical fiber loops, advanced digital signal processing holds great promise today for subscribers who desire broadband services such as high speed internet access, remote Local Area Network (LAN) access and switched digital video today. Technological advances have brought about Digital Subscriber Line (DSL) technology at high data rates, e.g., High-rate DSL (HDSL) and Asymmetric DSL (ADSL). For example, using ADSL technology, broadband signals are modulated by ADSL modems onto copper telephone loops at passband frequencies so that Plain Old Telephone Service (POTS) or another baseband service may be carried on the same pair of copper wires. Using the existing copper telephone loop is extremely cost effective as the installation of new cable and structure along with their associated labor and material costs are avoided.

Deployment of technologies such as DSL, however may be limited by the transmission characteristics of the telephone loop. As such, before a particular subscriber may utilize DSL technology for his or her broadband services, the broadband service provider has to determine or have determined the viability of deploying DSL to that subscriber. Thus, there is a need for a system and technique to determine whether the telephone loop is qualified to carry a DSL signal.

### BRIEF DESCRIPTION OF THE DRAWINGS

FIG. 1 is a block diagram of a DSL loop qualification system including a fuzzy impedance mismatch network in accordance with an embodiment of the invention;

FIG. 2 is a simplified schematic depiction of the DSL loop qualification system and fuzzy impedance mismatch network according to an embodiment of the invention;

FIG. 3 is a flow chart showing DSL loop qualification that determines the characteristics of the loop in accordance with an embodiment of the invention;

FIG. 4 shows the fuzzy inference system of FIG. 1 with its inputs and outputs;

FIG. 5 shows the fuzzy membership function for change in capacitance C₁ (ΔC₁) and change in capacitance C₂ (ΔC₂) implemented in the fuzzy inference system in accordance with an embodiment of the invention;

FIG. 6 shows the fuzzy membership function for change in inductance of L (ΔL) implemented in the fuzzy inference system in accordance with an embodiment of the invention; and

FIG. 7 shows the fuzzy membership function for change in echo level divided by the echo level (Δε/ε) implemented in the fuzzy inference system in accordance with an embodiment of the invention.

### DETAILED DESCRIPTION

Deployment of DSL technology is limited by the transmission characteristics of the telephone loop. The transmission characteristics of the telephone loop depend on the length of the copper line, its gauge, the presence of bridged taps, the quality of splices, the integrity of the shielding, load coils, impedance mismatches and interference. Specifically, line loss increases with line length and attenuation increases with increasing frequency and decreases as wire diameter increases. There are particular points along the telephone loop between the subscriber's termination and the originating central office (CO) where the loop is particularly susceptible to ingress noise. These points include, for example, the location of a bridged tap, the drop wire from the telephone pole to the home, and the wires within the home. At the aforementioned points ingress noise may be coupled into the loop. The presence of other telephone terminals connected to other pairs in the cable also leads to impulse noise. Furthermore, bridged taps create more loss, distortion, and echo. All these factors serve to limit the data transfer or information rate at which a subscriber may be connected to a broadband service provider over the telephone loop and are a major cause of connection problems subscribers currently face in making data connections via the public switched telephone network.

Service providers have several options to determine the environment the DSL signal operates in before they commit to service when a subscriber requests DSL service. The service provider may query the outside plant records to determine the loop configuration. Outside plant records more than likely would have been constructed from the original design records. In many cases, the records available are outdated and do not reflect changes that may have occurred in the outside plant as a result of maintenance and service orders. The end result is that the records are usually inaccurate and may not be relied upon to provide information required by the carrier to predict a telephone loop's ability to support DSL service. The approach described above does not provide the telephone loop characteristic information with a degree of accuracy required to confidently predict DSL performance over the loop.

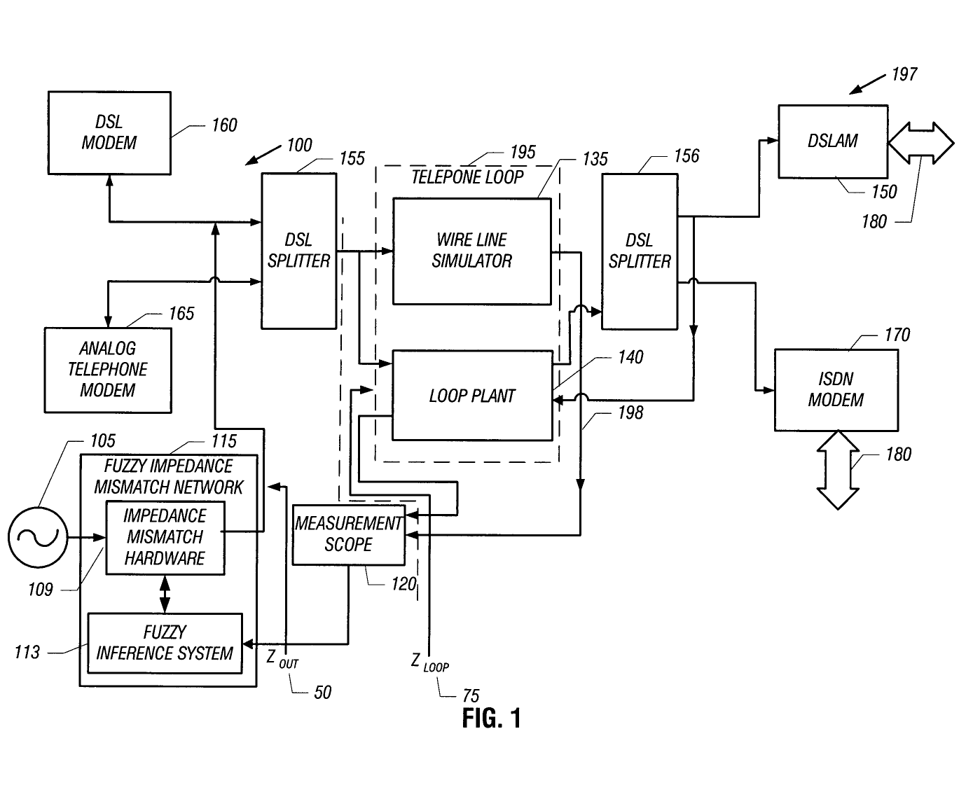

One way to accurately calculate loop characteristic information to determine if the telephone loop is capable of carrying DSL service is to use a fuzzy impedance mismatch network 115 as shown in FIG. 1. To determine the telephone loop length and other loop characteristics such as presence of bridge taps and insertion loss, a signal generator 105 generates impulse signals for transmission to the telephone loop 195 and CO 197. DSL qualification system 100 receives returned signals from telephone loop 195 and determines whether the telephone loop is capable of carrying DSL service. The returned signals received by DSL qualification system 100 include echoes of the impulse signals and noise and distortion generated from the various sources described above. In order to maximize the echoes to allow detection of the echo signal over noise and distortion, the impedances Zₒᵤₜ 50 and Zₗₒₒₚ 75 should be mismatched as described in greater detail below.

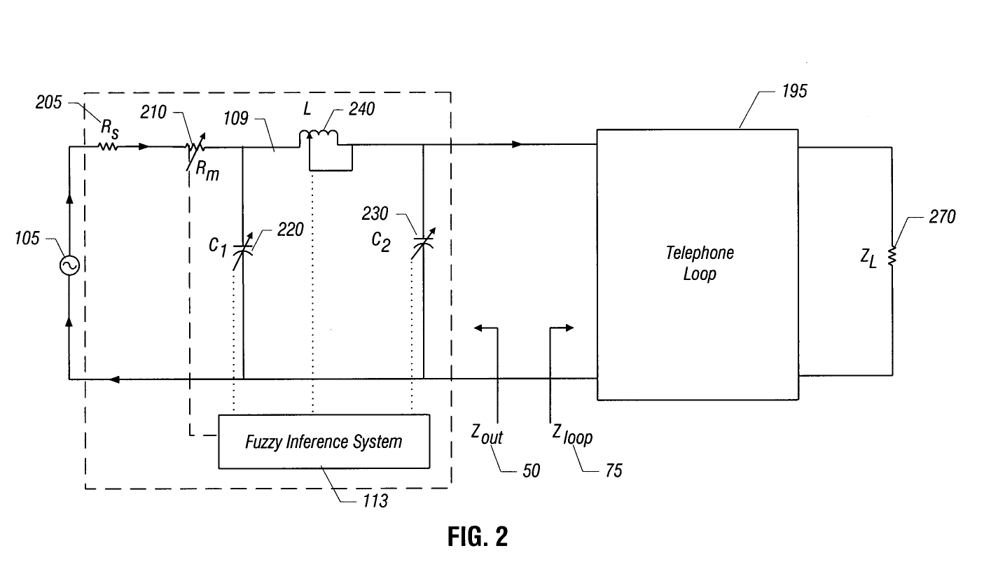

The DSL loop qualification system 100 in FIG. 1 includes the fuzzy impedance mismatch network 115 that receives output from signal generator 105. Fuzzy impedance mismatch network 115 may include impedance mismatch hardware 109 and a fuzzy inference system controller 113 in some embodiments. As shown in FIG. 2, in one embodiment of the invention impedance mismatch hardware 109 includes two adjustable capacitors C₁ 220 and C₂ 230, one adjustable inductor L 240, one adjustable resistor Rₘ 210 and one series resistor Rₛ 205. FIG. 2 is a simplified schematic depiction of the DSL loop qualification system and fuzzy impedance mismatch network of FIG. 1. As shown in FIG. 2, Zₒᵤₜ 50 is the output impedance of the fuzzy impedance mismatch network 115 coupled to signal generator 105. Zₗₒₒₚ 75 is the loop impedance of the telephone loop 195 that is shown in FIG. 1 and FIG. 2. Termination impedance ZL 270 may be the impedance of the CO switching equipment or other termination hardware present in the CO. Termination impedance Z_{L} in FIG. 1 may include the impedance of the ADSL splitter 156, Digital Subscriber Line Access Multiplexer (DSLAM) 150, Integrated Services Digital Network (ISDN) modem 170 and any other equipment coupled through connectors 180 present in CO 197.

In FIG. 2, when the resistor Rₘ is bypassed (i.e. replaced with a close to zero resistance wire), the output impedance of the mismatch network 115 is Zₒᵤₜ=R+jX where

$$\begin{matrix}R = \frac{{R}_{s}}{{( 1 - {ω}^{2} {LC}_{2} )}^{2} + {( ω {C}_{1} {R}_{S} + ω {C}_{2} {R}_{s} - {ω}^{3} {LC}_{1} {C}_{2} {R}_{s} )}^{2}} & Equation 1 \\ and & \\ X = \frac{\begin{matrix}{ω}^{3} {LC}_{1}^{2} {R}_{s}^{2} + 2 {ω}^{3} {LC}_{1} {C}_{2} {R}_{s}^{2} + ω L - ω {C}_{1} {R}_{s}^{2} - \\ ω {C}_{2} {R}_{s}^{2} - {ω}^{3} {L}^{2} {C}_{2} - {ω}^{5} {L}^{2} {C}_{1}^{2} {C}_{2} {R}_{s}^{2}\end{matrix}}{{( 1 - {ω}^{2} {LC}_{2} )}^{2} + {( ω {C}_{1} {R}_{s} + ω {C}_{2} {R}_{s} - {ω}^{3} {LC}_{1} {C}_{2} {R}_{s} )}^{2}} & Equation 2\end{matrix}$$

In Equation 1, the variable R corresponds to the real component of the output impedance Zₒᵤₜ and in Equation 2 the variable X corresponds to the imaginary component of the output impedance. Each of the components Rₛ, L, C₁ and C₂ in Equation 1 and Equation 2 is shown in FIG. 2 and described above. The variable ω in Equation 1 may be defined as ω=2πf and corresponds to the radian frequency which is the frequency generated by signal generator 105 that may be 50 Hertz or 60 Hertz. The telephone loop impedance Zₗₒₒₚ is Zₗₒₒₚ=R(loop,Z_{L})+jX(loop,Z_{L}) and includes a real component R(loop, Z_{L}) and a reactive frequency dependent component X(loop, Z_{L}). R(loop, Z_{L}) and X(loop, Z_{L}) are dependent on loop length, loop type and termination impedance Z_{L}. By mismatching Zₗₒₒₚ and Zₒᵤₜ (i.e. making ratio Zₗₒₒₚ:Zₒᵤₜ as large as possible) using the fuzzy inference system controller 113, the echoes can be determined so that the time delay and other loop characteristics are accurately estimated.

Returning now to FIG. 1, the DSL loop qualification system 100 may contain a measurement scope 120 to receive echo signals in the return path from telephone loop 195. The measurement scope 120 may be a microprocessor based instrument such as an oscilloscope including an analog-to-digital (A/D) converter and application software to detect, capture and process the received echo signal. The measurement scope outputs the echo value ε and change in echo value ε to fuzzy inference system 113. The echo value ε is the magnitude of the echo signal that may be calculated in volts or decibels by the measurement scope. The change in echo value ε is the difference between the echo value from a signal pulse with one set of values for C₁, C₂, and L and the echo value from the signal pulse transmit in the next iteration (described below) with another set of values for C₁, C₂, and L. DSL splitter 155 separates the data signals from the voice signals transmit over the copper lines of the telephone loop 195. In one embodiment of the invention shown in FIG. 1, telephone loop 195 includes a wireline simulator 135 and loop plant 140. Wireline simulator 135 approximates the echo and noise signals of the loop plant 140 to allow the initial settings for the impedance mismatch hardware 109. Wireline simulator 135 may have access to loop plant records 140 that provide a good estimate of the expected echo signal for initializing the impedance mismatch hardware 109. Thus, wireline simulator 135 provides a reference model for the loop plant 140. The estimated echo signals from wireline simulator 135 travels through return path 198 to measurement scope 120. In some embodiments, telephone loop plant 140 is the path over which the DSL signal travels to the CO 197 and returns from the CO through return path 199 to measurement scope 120. The DSL signal is affected by various characteristics of the loop plant including copper cable length, gauge, presence of bridged taps, quality of splices, integrity of shielding, load coils, impedance mismatches and interference. After traveling through loop plant 140, the DSL signal is transmitted to DSL splitter 156 in CO 197 that separates DSL data signals and voice signals that may have overlapped during transmission through loop plant 140. The DSL signal may then be transmitted to a DSLAM 150 or ISDN modem 170 for high-speed transmission to the internet service providers (ISP) network. If the DSL loop qualification system 100 has determined that the telephone loop is qualified to carry the DSL signal, DSL modem 160 and analog telephone modem 165, as shown in FIG. 1, in one embodiment may verify the results of the DSL loop qualification system. Verification may occur by simultaneously sending and receiving an actual DSL signal as well as an analog modem signal over the telephone loop.

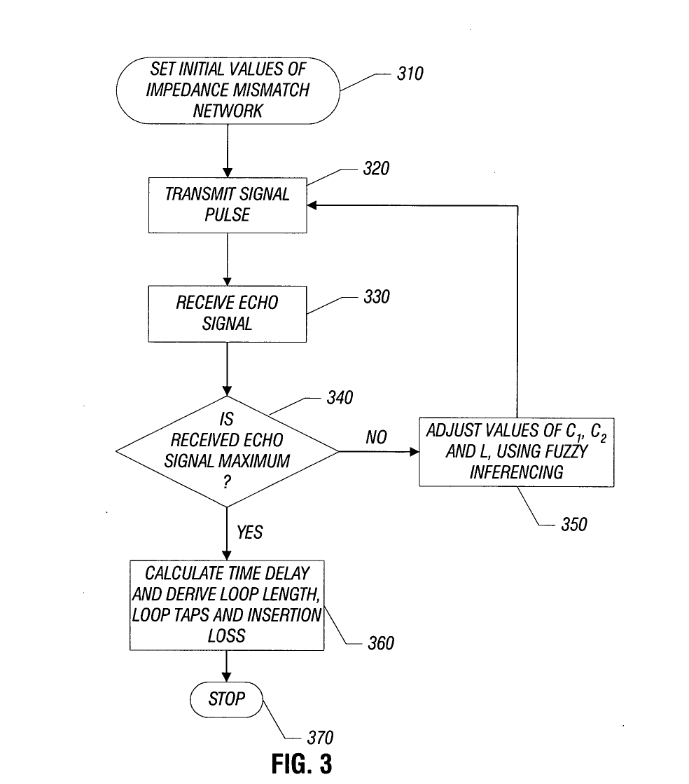

Referring to FIG. 3, one embodiment of a technique for DSL loop qualification that determines the characteristics of the loop is shown. The technique shown in FIG. 3 may be implemented in software executing on a processor. In one embodiment, the software may be executing on a processor located in measurement scope 120. In another embodiment, the software may be executing on a processor located in a separate central controller (not shown in FIG. 1) in DSL qualification system 100. Wireline simulator 135, as described above, sets the initial values of impedance mismatch hardware 109 in oval 310. Next, in block 320, signal generator 105 transmits a signal pulse to the impedance mismatch hardware 109 and the loop plant 140 through DSL splitter 155. Measurement scope 120 receives an echo signal that may be noisy from loop plant 140 in block 330. The echo signal of maximum value is determined in diamond 340 by selecting a maximum from the previous and present values of echo signals. If the previous echo signal is the maximum (i.e. previous echo signal is greater than present echo signal) then the echo signal has reached its maximum. If the received echo signal is determined to be a maximum value in diamond 340, then the time delay between the echo signal and the transmit signal pulse is calculated in block 360. Other characteristics of the loop including the loop length, loop taps and insertion loss are also calculated based on the relative amplitude and time difference of the echo signal and the transmit signal pulse. Thus, the loop length may be determined by multiplying the time difference by the speed of signal propagation in the telephone loop (i.e. approximately the speed of light 299,792,458 meters/sec multiplied by a constant). Similarly, the loop taps and insertion loss may be determined by examining the change in amplitude of the echo signal from the transmit signal pulse. If the received echo signal is not determined to be the maximum value in diamond 340, then the fuzzy inference system 113 adjusts the values of the impedance mismatch hardware 109 (described in greater detail below) in block 350. A signal pulse is again transmit in block 320 and the received echo signal 330 compared to the previous echo signal to determine a maximum value 340. This iterative process is continued until the maximum echo signal is determined and the loop characteristics are calculated.

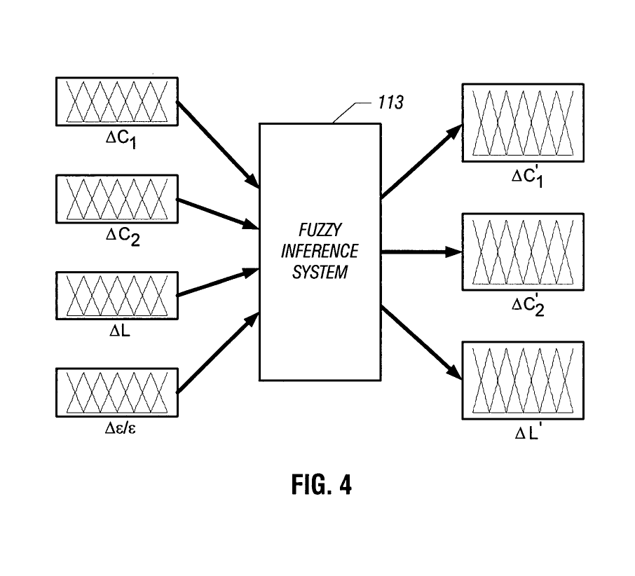

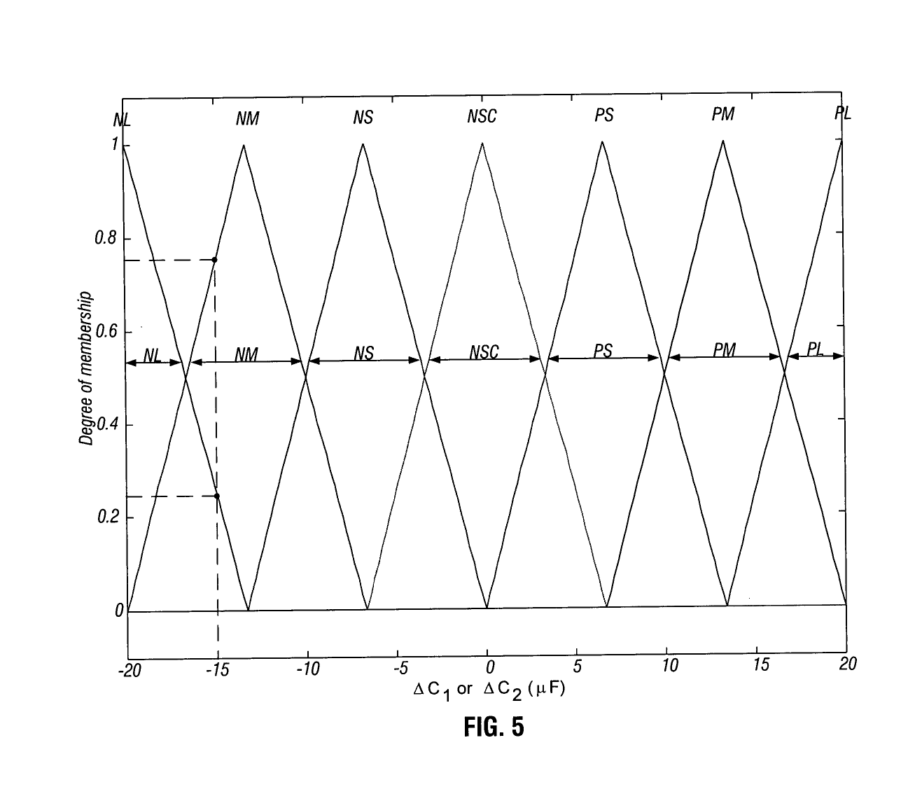

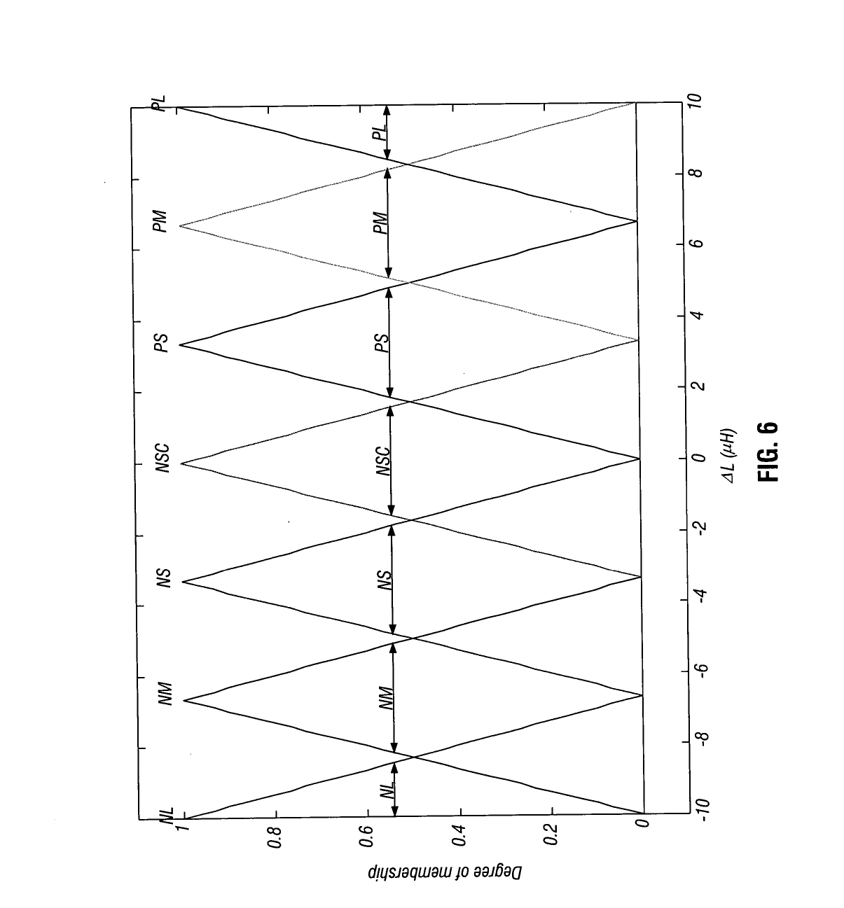

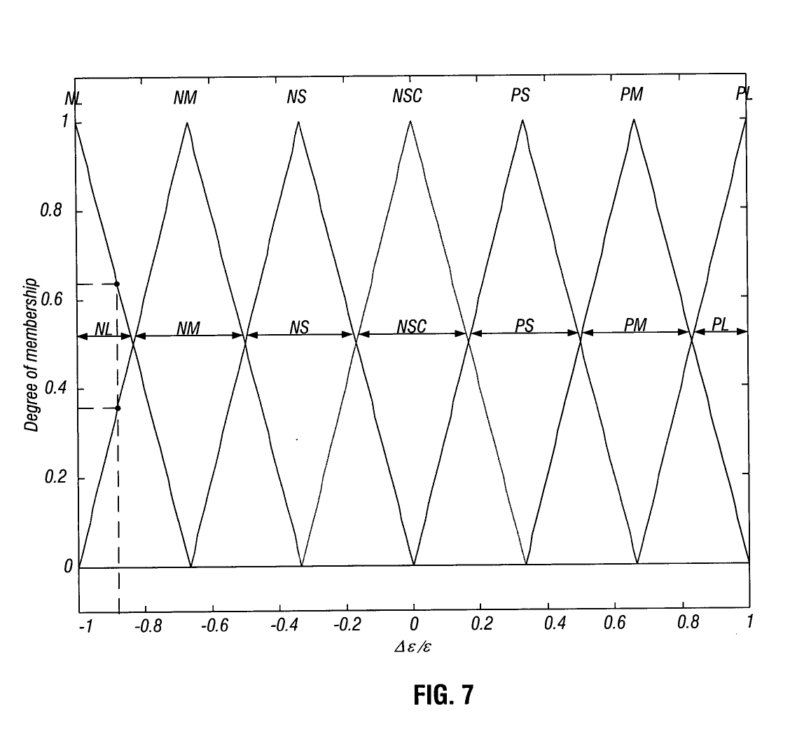

Turning now to FIG. 4, maximization of the received echo signal is performed by the fuzzy inference system 113. The fuzzy inference system 113 receives as inputs change in capacitance C₁ (ΔC₁), change in capacitance C₂ (ΔC₂), change in inductance L(ΔL), and the change in echo value versus the echo value (Δε/ε). The fuzzy inference system 113 outputs to the impedance mismatch hardware 109 a new change in capacitance C′₁ (ΔC′₁), new change in capacitance C′₂ (ΔC′₂), and new change in inductance L′(ΔL′) using the fuzzy membership functions in FIG. 5, FIG. 6, and FIG. 7. Fuzzy membership functions shown in FIGS. 5-7 are derived by incorporating all the known input-output behaviors, uncertainties and qualitative design objectives of the DSL qualification system. The output values ΔC′₁, ΔC′₂, and ΔL′ become the input values ΔC₁, ΔC₂, and ΔL, respectively, for the fuzzy inference system 113 in the next iteration of maximization of the received echo signal shown in FIG. 3. As shown in FIG. 5, each fuzzy membership function is a triangle with corresponding labels NL, NM, NS, NSC, PS, PM, and PL. Fuzzy membership functions translate crisp input values into fuzzy output values. Thus, for example as shown in FIG. 5, a crisp ΔC₁ input value of −15 μF would be translated into fuzzy output values of NL with degree of membership 0.25 (or 25%) and NM with degree of membership 0.73 (or 73%). The operation of the fuzzy inference system using the fuzzy membership functions and inputs to generate the outputs is described in more detail below.

The fuzzy inference system includes: (a) translation of a crisp input value into a fuzzy output value known as fuzzification, (b) rule evaluation, where the fuzzy output values are computed, and (c) translation of a fuzzy output to a crisp value known as defuzzification. The fuzzy inference system 113 includes a range of values for the input and output variables as shown in FIGS. 5-7. Thus, for example as shown in FIG. 5, ΔC₁ varies over the range −20 μF to 20 μF and as shown in FIG. 6, ΔL varies over the range −10 μH to 10 μH. Labels for the triangular shaped membership functions for each of the input and output values of the fuzzy inference system are:

| | |
|---|---|
| NL | negative large |
| NM | negative medium |
| NS | negative small |
| NSC | no significant change |
| PS | positive small |
| PM | positive medium |
| PL | positive large |

Each of the input and output variables of the fuzzy inference system 113 uses a set of rules to maximize the echo value:

| | |
|---|---|
| IF ΔC₁ is NL and Δε/ε is NL then ΔC′₁ is NM | Rule 1 |
| IF ΔC₁ is NM and Δε/ε is NL then ΔC′₁ is NS | Rule 2 |
| ... | |
| IF ΔC₁ is NL and Δε/ε is NM then ΔC′₁ is NS | Rule A + 1 |
| IF ΔC₁ is NL and Δε/ε is NS then ΔC′₁ is NSC | Rule A + 2 |
| ... | |
| IF ΔC₁ is NM and Δε/ε is NM then ΔC′₁ is NS | Rule B + 1 |
| IF ΔC₁ is NM and Δε/ε is NS then ΔC′₁ is NSC | Rule B + 2 |
| ... | |
| IF ΔC₂ is NL and Δε/ε is NL then ΔC′₂ is NM | |
| IF ΔC₂ is NM and Δε/ε is NL then ΔC′₂ is NS | |
| ... | |
| IF ΔC₂ is NL and Δε/ε is NM then ΔC′₂ is NS | |
| IF ΔC₂ is NL and Δε/ε is NS then ΔC′₂ is NSC | |
| ... | |
| IF ΔL is NL and Δε/ε is NL then ΔL′ is NM | |
| IF ΔL is NM and Δε/ε is NL then ΔL′ is NS | |
| ... | |
| IF ΔL is NL and Δε/ε is NM then ΔL′ is NS | |
| IF ΔL is NL and Δε/ε is NS then ΔL′ is NSC | |
| ... | |

The rules given above are derived by incorporating all the known input-output behaviors, uncertainties and qualitative design objectives of the DSL qualification system. Each label is given to each fuzzy input ΔC₁, ΔC₂, ΔL, and (Δε/ε) in a rule and the appropriate fuzzy output generated. The fuzzy inputs ΔC₁, ΔC₂, ΔL, and (Δε/ε) go through the fuzzy inference system to generate new crisp outputs ΔC′₁, ΔC′₂, and ΔL′ to adjust the impedance of the mismatch network.

One example of the operation of the fuzzy inference system for selection of C₁ is described. During fuzzification, a crisp ΔC₁ input value of −15 μF is translated into fuzzy output values. Similarly, a crisp (Δε/ε) input value of −0.9 is translated into fuzzy output values. Thus, as shown in FIG. 5, −15 μF is fuzzified into NL with degree of membership 0.25 (or 25%) and NM with degree of membership 0.73 (or 73%). The fuzzy values for (Δε/ε) of −0.9 are NM with degree of membership 0.33 (33%) and NL with degree of membership 0.67 (67%) as shown in FIG. 7. Next, the entire set of rules in the fuzzy inference system is evaluated. Rules for which the IF-then rule conditions of ΔC₁ are satisfied are executed to generate the fuzzy output values of ΔC′₁. For ΔC₁ with a value of −15 μF and (Δε/ε) with a value of −0.9, Rule 1, Rule 2, Rule A+1 and Rule B+1 are executed to generate ΔC′₁ values. Specifically, the ΔC′₁ values are NM with degree of membership 0.25 (25%) for Rule 1, NS with degree of membership 0.67 (67%) for Rule 2, NS with degree of membership 0.25 (25%) for Rule A+1, NS with degree of membership 0.33 (33%) for Rule B+1. During defuzzification, the 25% NM, 67% NS, 25% NS, and 33% NS are combined using the center of gravity (COG) technique in order to produce a crisp output value. In the center of gravity technique, the membership functions of the variables such as AC, are truncated to their respective degrees of membership and combined. Next, the center of gravity (or balance point) of the combined membership functions that have been truncated is computed. The center of gravity may be computed as a weighted average of the truncated and combined fuzzy membership functions to produce the crisp output value. Using the COG technique produces the crisp output value of 8.76 μF for the value of ΔC′₁. The value of C₁ is then decreased by 8.76 uF to adjust the overall impedance of the mismatch network. Selection of C₂ and L can be determined in a similar way as described above by the fuzzy inference system 113 to adjust the impedance of the mismatch network to generate a maximal echo signal. The time between transmission of the impulse signal and reception of its echo signal may be used to determine the length of the telephone loop and other loop characteristics. These loop characteristics may then be used to determine if the telephone line is capable of carrying DSL service.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A system, comprising:
a signal generator;
impedance mismatch hardware coupled to the signal generator, wherein the impedance mismatch hardware includes at least one impedance; and
a controller coupled to the impedance mismatch hardware, said controller to adjust the impedance mismatch hardware, wherein the controller to determine whether a telephone loop is capable of carrying Digital Subscriber Line service.

2. The system of claim 1, wherein the impedance is resistive, capacitive or inductive impedance.

3. The system of claim 2, further comprising a termination impedance coupled to the impedance mismatch hardware.

4. The system of claim 1, wherein the impedance mismatch hardware modifies one or more characteristics of a received signal, wherein the received signal is an echo of a signal transmit from the signal generator.

5. The system of claim 4, wherein the received signal determines the capability of a subscriber's loop to carry Digital Subscriber Line service.

6. The system of claim 4, wherein the controller is a fuzzy inference system controller.

7. The system of claim 6, wherein the fuzzy inference system controller adjusts the impedance of one or more components in the impedance mismatch hardware to modify one or more characteristics of the received signal.

8. The system of claim 7, wherein after the received signal is modified to a maximal value, a time between the transmit signal and received signal is used to determine a length of the telephone loop and other loop characteristics.

9. The system of claim 8, wherein the length of the telephone loop and other loop characteristics are used to determine if the telephone loop is capable of carrying DSL service.

10. A method, comprising:
transmitting a first signal;
receiving a second signal, wherein the second signal has an amplitude; and
adjusting one or more impedances to amplify the second signal amplitude using impedance mismatch hardware.

11. The method of claim 10, further comprising:
calculating a time delay from the amplified second signal amplitude; and
wherein the impedance mismatch hardware couples to a fuzzy inference system controller.

12. The method of claim 11, further comprising determining loop length, loop taps, and insertion loss from the time delay.

13. The method of claim 12, further comprising determining whether a telephone loop is capable of carrying Digital Subscriber Line service from the loop length, loop taps, and insertion loss.

14. An article comprising a storage medium storing instructions that when executed by a machine result in:
transmitting a first signal;
receiving a second signal containing an amplitude, wherein the second signal is an echo of the first signal; and
adjusting one or more impedances to amplify the second signal amplitude.

15. The article of claim 14, wherein the instructions when executed also result in:
determining whether the second signal amplitude is an amplified value;
calculating a time delay from the amplified value; and
adjusting the impedances by fuzzy inferencing.

16. The article of claim 15, wherein the instructions when executed also result in:
determining loop characteristics from the time delay.

17. The article of claim 15, wherein the instructions when executed also result in:
determining loop length, loop taps, and insertion loss from the time delay.

18. The article of claim 17, wherein the instructions when executed also result in:
determining whether a telephone loop is capable of carrying Digital Subscriber Line service from the loop length, loop taps, and insertion loss.
